(19) United States
(12) Patent Application Publication
(10) Pub. No.: US 2007/0108221 A1
(43) Pub. Date: May 17, 2007

(54) Method and Apparatus for Vending Cryogenically Frozen Dessert Particles

(76) Inventor: Thomas R. Mosey, Mystic, CT (US)

Correspondence Address: Rudolf O. Siegesmund;Gordon & Rees, LLP, Suite 2650, 2100 Ross Avenue, Dallas, TX, 75201, US

(21) Appl. No.: 11/556,250

(22) Filed: Nov. 3, 2006

Related U.S. Application Data
(60) Provisional application No. 60/736,760, filed on Nov. 15, 2005.

(51) Int. Cl. G07F 9/10

(52) U.S. Cl. 221/150 R

(57) ABSTRACT

An ice cream cup having a flat lid and a spoon inside provides an improved method for vending cryogenically frozen ice cream particles by reducing vending errors and providing a spoon in one lift operation. The ice cream cup is employed in a vending machine having a plurality of sleeves and a plurality of the ice cream cups inserted in each of the sleeves where a vacuum lift device extracts an ice cream cup from the freezer and deposits the ice cream cup in an extraction area. Spoons are inserted inside the ice cream cups when the cryogenically frozen ice cream particles are packaged, so that a person purchasing the cup of cryogenically frozen ice cream particles can open the package and have a spoon readily available to consume the cryogenically frozen ice cream particles.

### RELATED APPLICATIONS

This application claims priority from provisional application 60/736,760, Method of converting Ice Cream Vending Machines to Vend Cryogenically Frozen Dessert Particles” filed Nov. 15, 2005.

### FIELD OF THE INVENTION

The present invention relates to a method for vending cryogenically frozen ice cream particles served with spoons in prepackaged cups.

### BACKGROUND OF THE INVENTION

Making novelty ice cream by dripping and/or streaming a liquid ice cream mix into liquid nitrogen is known. For example, U.S. Pat. No. 6,349,549 discloses one method of manufacturing cryogenically frozen particles of ice cream. These cryogenically frozen particles of ice cream present a consumer with novel aspects. The particles initially taste different than regular ice cream because of the small shapes, and the particles can be scooped in a spoon or poured into the mouth. The novel aspects of cryogenically frozen ice cream make it a popular product at many locations, but the use of vending machines is particularly advantageous for sale and distribution.

Ice cream vending machines are commercially available for regular ice cream products, such as the ice cream vending machine disclosed in U.S. Pat. No. 5,240,139. The ice cream vending machines have a freezer compartment, a lift device which extracts ice cream containers from the freezer compartment and deposits the ice cream containers in an extraction point. Therefore, a consumer can pay for an ice cream product, and after the machine lifts the ice cream product from the freezer and places the ice cream product at the extraction point, the consumer can grasp the ice cream product to remove it from the vending machine for consumption. However, these ice cream vending machines do not maintain a low enough freezer temperature to keep the ice cream particles from scintering or sticking together.

Ice cream vending machines have been converted to the lower temperatures necessary to keep the cryogenically frozen ice cream particles from scintering, or sticking together, as disclosed by U.S. Pat. No. 6,481,226. Ice cream vending machines normally are sold with the coolant inserted and the pipe crimped. In order to achieve lower temperatures in the freezer compartment, a valve needs to be inserted, the coolant drained and a different coolant inserted.

A known method of serving ice cream from a vending machine is to package the ice cream in cups with flat lids in order to facilitate mechanical retrieval from a freezer compartment and placement at an extraction point. U.S. Pat. No. 5,027,698 discloses an improvement to a vending machine using ice cream packaged in cups with flat lids that removes the lid from the cup, and adds toppings to the ice cream before placing the cup at an extraction point. The '698 further teaches that a spoon can be dispensed along with the opened cup of ice cream.

Problems can arise when using a vacuum lift to extract a container of cryogenically frozen ice cream from a vending machine. If the contact between the vacuum lift and the lid of the ice cream container separates so that suction is lost, the cup will fall back into the freezer. If the cup falls back into the freezer, the cup may fall in a way that prevents access to other cups. Moreover, vending machines that dispense ice cream using a vacuum lift normally extract ice cream cups by opening a lid to a refrigerated area to allow a vacuum arm to enter the refrigerated area to remove a cup. Therefore, a very serious problem arises if the cup falls in a way that prevents the lid from closing. In the event that the lid cannot close properly, the lower temperatures necessary for maintaining cryogenically frozen ice cream cannot be maintained and the product will scinter, losing its free flowing characteristics. If the temperatures climb further, the ice cream will melt. Such breaks in suction by the vacuum lift are known as vending errors.

A further problem arises in providing spoons to eat the ice cream. Spoons cannot be attached to the top of the cup or the spoon will interfere with the vacuum lift. If spoons are provided separately, the vacuum lift would have difficulty in lifting a separate spoon, and additional operations would be required. In addition, spoons must be wrapped for hygiene. The vacuum lift would have even greater difficulty in lifting a wrapped spoon since it would be very difficult to attain suction on the wrapped spoon.

What is needed beyond the prior art is a method for vending cryogenically frozen ice cream particles to reduce vending errors and to provide a spoon in one lift operation.

### SUMMARY OF THE INVENTION

An ice cream cup having a flat lid and a spoon inside provides an improved method for vending cryogenically frozen ice cream particles by reducing vending errors and providing a spoon in one lift operation. The ice cream cup is employed in a vending machine having a plurality of sleeves and a plurality of the ice cream cups inserted in each of the sleeves where a vacuum lift device extracts an ice cream cup from the freezer and deposits the ice cream cup in an extraction area. Spoons are inserted inside the ice cream cups when the cryogenically frozen ice cream particles are packaged, so that a person purchasing the cup of cryogenically frozen ice cream particles can open the package and have a spoon readily available to consume the cryogenically frozen ice cream particles.

### BRIEF DESCRIPTION OF THE DRAWINGS

FIG. 1 depicts an open vending machine showing the freezer unit;

FIG. 2 depicts a sleeve;

FIG. 3 depicts an open freezer chest with an array of sleeves;

FIG. 4 depicts a vacuum lift and transport device;

FIG. 5A depicts an open ice cream cup with a spoon;

FIG. 5B depicts a closed ice cream cup with a flat lid; and

FIG. 6 depicts an ice cream vending machine.

### DETAILED DESCRIPTION OF THE PREFERRED EMBODIMENT

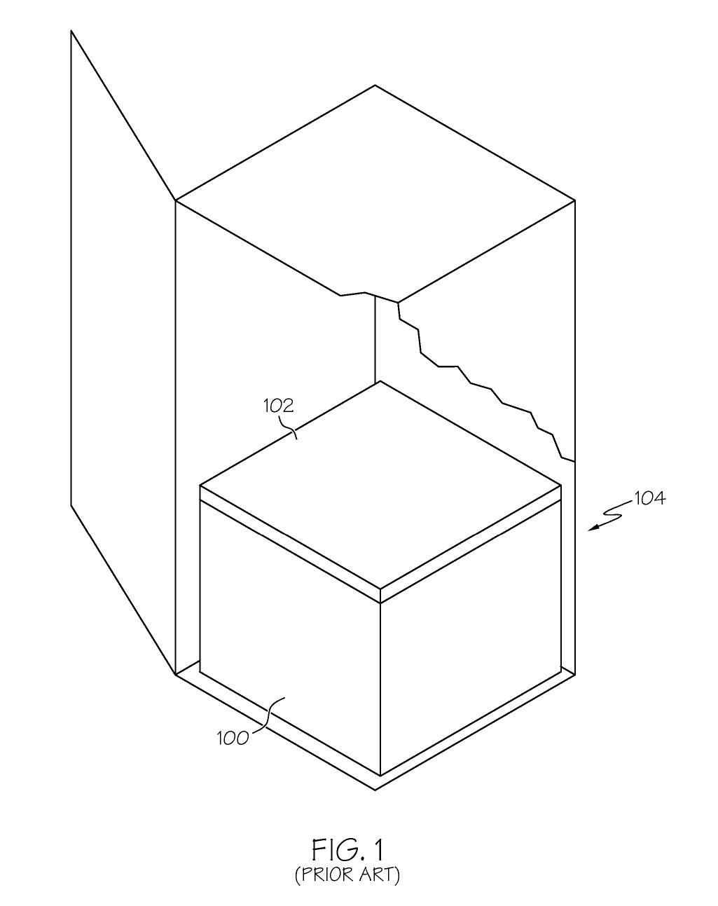

FIG. 1 depicts vending machine 104 having freezer unit 100 with lid 102 hingedly attached to freezer unit 100.

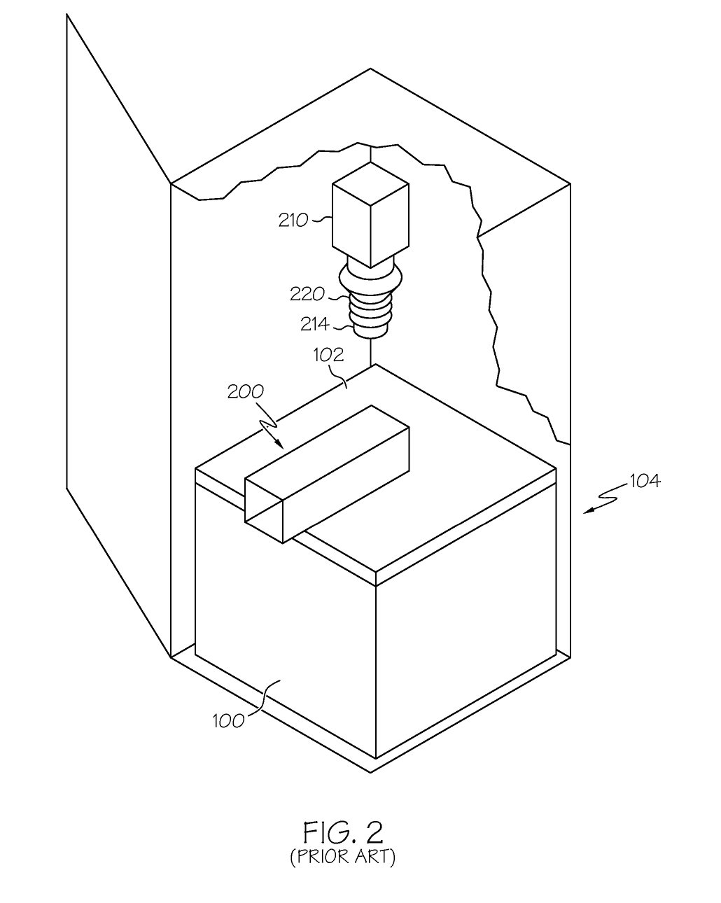

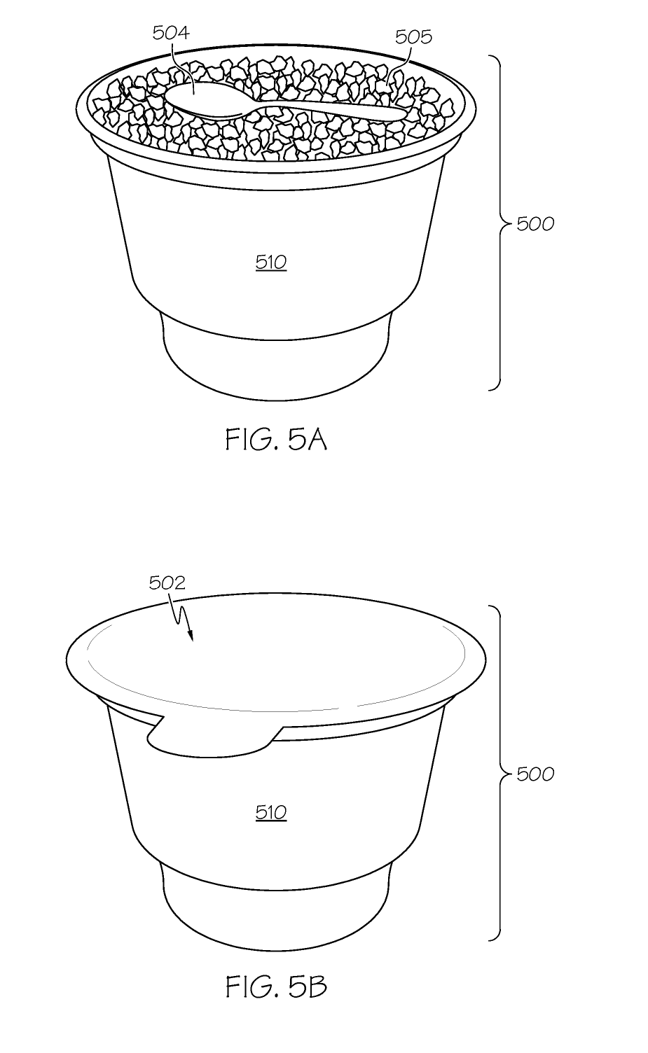

FIG. 2 depicts vacuum lift device 210 with vacuum lift extension device 220. Sleeve 200 is shown resting on lid 102. Sleeve 200 is generally square in cross section and has a length approximately equal to the depth of freezer unit 100. Sleeve 200 dimensions are sufficient to allow insertion of ice cream cups such as ice cream cup 500 (see FIG. 5) so that ice cream cups can be stacked one on top of the other within sleeve 200.

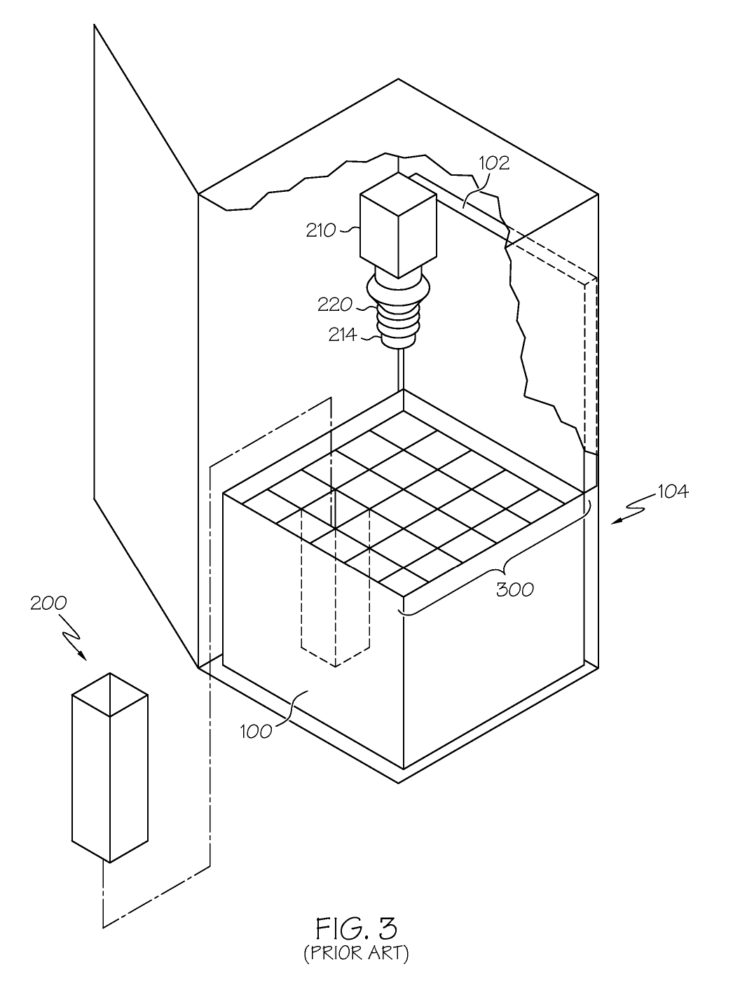

FIG. 3 depicts freezer 100 with lid 102 raised by a lifting arm (not shown). Array 300 of sleeves 200 is disposed within freezer 100 so that freezer 100 is divided into an array of sleeves each capable of holding approximately 20 ice cream cups. Ice cream cups are disposed within sleeve 200 so that a flat top surface of lid 502 of ice cream cup 500 is horizontal and presented for engagement with vacuum nozzle 214. Vacuum lift extension 214 can be lowered to contact the flat surface of ice cream cup 500 to adhere to lid 502 of ice cream cup 500 so that ice cream cup 500 can be lifted out of sleeve 200 and moved to a location from which it can be extracted by a purchaser.

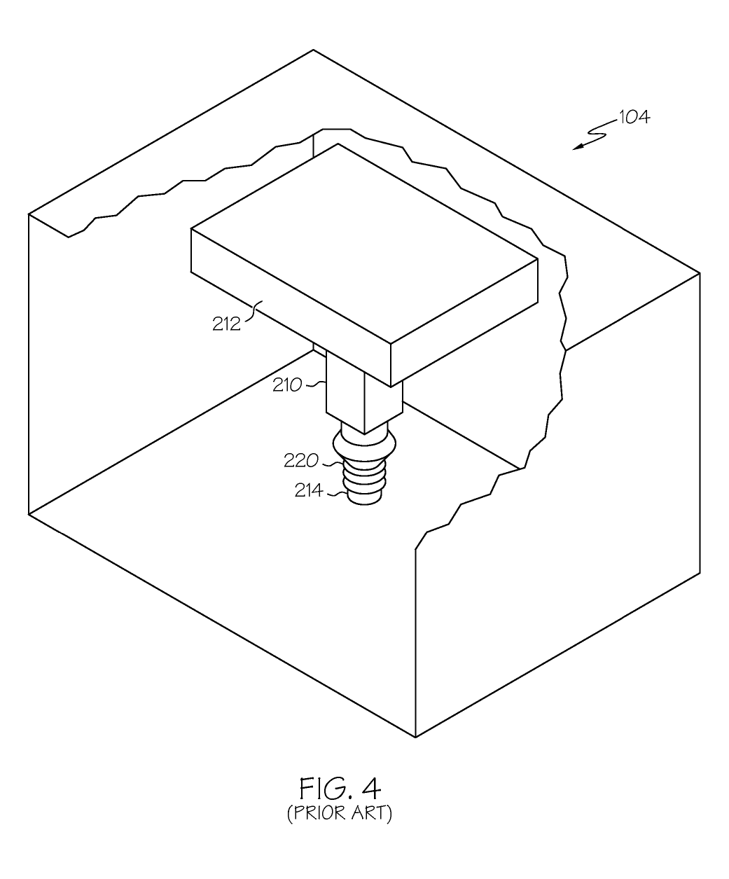

FIG. 4 depicts vacuum lift device 210 and transport device 212 within shell of vending machine 104. Vacuum lift extension device 220 extends below vacuum lift device 210, having vacuum nozzle 214 at the lower end of vacuum lift device 210.

FIG. 5A depicts ice cream cup 500 having spoon 504 placed on top of cryogenically frozen ice cream particles 505 inside container 510. Unlike traditional frozen ice cream, cryogenically frozen ice cream particles kept a proper temperature will not melt or scinter. Therefore, spoon 504 will not adhere to cryogenically frozen ice cream particles 505 and spoon 504 can be removed from cryogenically frozen ice cream particles 505 without becoming messy and sticky. Spoon 504 remains clean and dry while ice cream cup 500 is kept at a cryogenic temperature and for a sufficient time after dispensing ice cream cup 500 for a customer to open lid 502 and remove spoon 504. Normally, spoons cannot be packed inside a container of regular ice cream because the ice cream would adhere to the spoon. The lid of traditional ice cream containers normally contacts the ice cream as part of the bonding of the lid to the ice cream container. However, the unique characteristics of cryogenically frozen ice cream particles allows placement of a spoon inside the ice cream cup.

FIG. 5B depicts ice cream cup 500 having flat lid 502 affixed to container 510 to facilitate acquisition by a vacuum lift device. Lid 502 is affixed to container 510 after spoon 504 is placed inside cup 510. Normally, lid 502 is affixed to container 510 by heat sealing. Lid 502 is affixed to container 510, and lid 502 and container 510 are dimensioned so that lid 502 will provide a flat circular surface area that exceeds the circumference container 510 so that vacuum nozzle 214 (see FIG. 4) is provided with a target area larger than the circumference of container 510 to reduce vending errors.

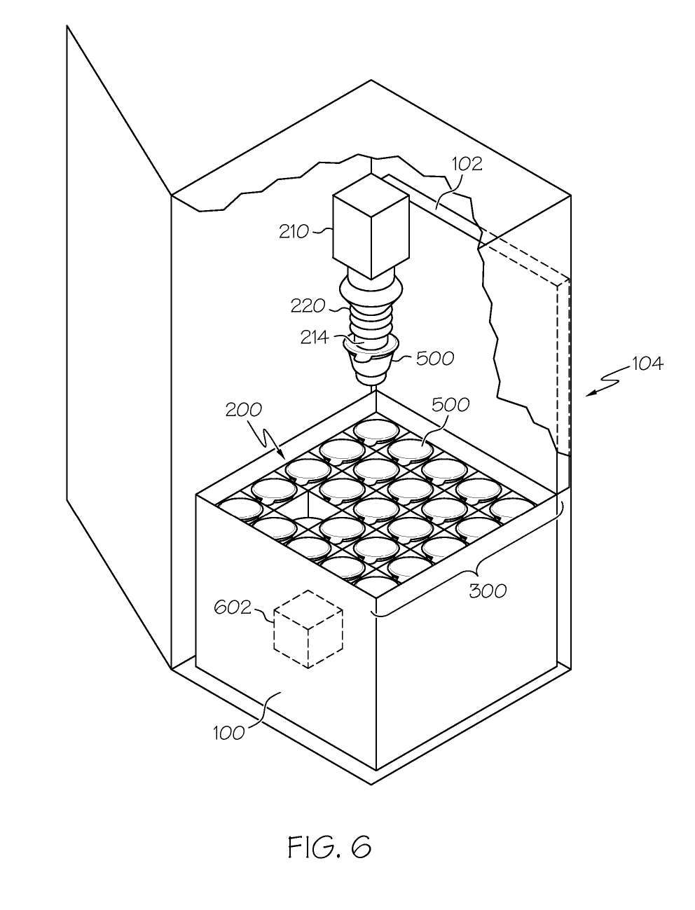

FIG. 6 depicts freezer unit 100 within shell of vending machine 104. Lid 102 is in open position and vacuum lift device 210 with vacuum lift device extension 220 and vacuum nozzle 214 is shown extracting cup 500 from sleeve 200 of array 300. Cup 500 may be placed in extraction point 602 so that a consumer may grasp and remove cup 500.

It will be understood from the foregoing description that various modifications and changes may be made in the preferred embodiment of the present invention without departing from its true spirit. Specifically, one skilled in the art could adapt the present invention can for other cryogenically frozen dessert particles besides ice cream. It is intended that this description is for purposes of illustration only and should not be construed in a limiting sense. The scope of this invention should be limited only by the language of the following claims.

What is claimed:

1. An improved ice cream vending machine comprising:
a housing;
a freezer disposed within the housing and adapted for cryogenically frozen ice cream particles;
a plurality of sleeves adapted for insertion within the freezer;
a plurality of cups having a flat lid disposed within each of the plurality of sleeves;
wherein the plurality of sleeves position the plurality of cups so that a vacuum lift device and extension can pick up one of the plurality of cups and deposit the cup in an extraction area; and
wherein each of the plurality of cups contain cryogenically frozen ice cream particles and a spoon.

2. An improved method of vending cryogenically frozen ice cream comprising:
placing a spoon inside a cup containing cryogenically frozen ice cream particles;
placing the cup into a vending machine adapted to dispense cups of cryogenically frozen ice cream particles; and
responsive to a consumer selecting the cup, dispensing the cup from the vending machine.

3. An improved method of packaging a plurality of cryogenically frozen ice cream particles comprising:
placing a spoon inside a cup containing the plurality of cryogenically frozen ice cream particles.

4. The improved method of packaging a plurality of cryogenically frozen ice cream particles of claim 3, further comprising:
placing a lid on the cup, wherein the lid is adapted for use by a vacuum lift device in an ice cream vending machine.

5. An improved vending machine comprising:
a housing;
a freezer disposed within the housing and adapted for cryogenically frozen dessert particles;
a plurality of sleeves adapted for insertion within the freezer;
a plurality of cups having a flat lid disposed within each of the plurality of sleeves;
wherein the plurality of sleeves position the plurality of cups so that a vacuum lift device and extension can pick up one of the plurality of cups and deposit the cup in an extraction area; and
wherein each of the plurality of cups contain cryogenically frozen desert particles and a spoon.
